(19) United States
(12) Patent Application Publication
(10) Pub. No.: US 2013/0278638 A1
(43) Pub. Date: Oct. 24, 2013

(54) FLOWCHART DRAWING APPARATUS, FLOWCHART DRAWING METHOD AND PROGRAM

(71) Applicants: Chie Yoshikawa, Yokohama (JP); Kazuyuki Ichikawa, Tokyo (JP); Kensuke Bandai, Yokohama (JP)

(72) Inventors: Chie Yoshikawa, Yokohama (JP); Kazuyuki Ichikawa, Tokyo (JP); Kensuke Bandai, Yokohama (JP)

(73) Assignee: HITACHI, LTD., Tokyo (JP)

(21) Appl. No.: 13/991,300

(22) PCT Filed: Feb. 17, 2011
(86) PCT No.: PCT/JP2011/053396

§ 371 Date: Jun. 3, 2013

(30) Foreign Application Priority Data
Jan. 14, 2011 (JP) 2011-005558

(51) Int. Cl. G06T 11/20

(52) U.S. Cl. CPC G06T 11/206
USPC 345/681

(57) ABSTRACT

A flowchart drawing apparatus (1) receives an input of a new process from an input apparatus (2). Further, in a case where a display position of the input process is overlapped with a display position of a connector of an existing flowchart stored in a part information table (300), a part information managing section (202) performs a process of inserting the input process between processes positioned on upper and lower sides of the connector. Next, a flow position calculating section (203) calculates a display position so that the respective processes are equivalently arranged, and a flow display section (204) displays a flowchart that is a process result on a display apparatus (3).

### TECHNICAL FIELD

The present invention relates to a flowchart drawing apparatus, a flowchart drawing method, and a program.

### BACKGROUND ART

A work flowchart is used as a tool that visualizes the flow of work that uses work knowledge, knowhow or the like in companies. The work flowchart is configured by nodes that indicate operations or process content performed in the work, connection lines between nodes, and the like.

In a software editing function of displaying objects as in a work flow or the like on a display device in the form of a flowchart, in the related art, it is necessary that a user personally performs the following operations in arrangement of the objects.
(1) Arrangement of a newly added object
(2) Movement of an object after arrangement in consideration of a drawing region
(3) Connection between objects (deletion of an unnecessary connection and connection between an added object and an existing object)

In particularly, it is necessary that the user performs the object movement operation of (2) with deliberation so that the flow is drawn in the form of being easily viewed, which demands a large amount of work time according to the size or complexity of the flow.

As a technique for efficiently drawing the work flowchart, a method of drawing a flowchart using a file as an input in the form of a table that indicates respective processes of a work flow, without an editing function of drawing a flowchart, has been disclosed (see PTL 1).

Further, a method of performing an automatic control so that connection lines of a flowchart during drawing do not intersect with each other has been disclosed (see PTL 2).

### CITATION LIST

### Patent Literature

[PTL 1] JP-A-2001-134653

[PTL 2] JP-A-2009-110274

### SUMMARY OF INVENTION

### Technical Problem

In the technique disclosed in PTL 1, it is difficult to perform editing after viewing the entire picture of a completed flowchart. Further, since the work flow that is a target has a small number of components and cannot take a complex form, the technique is not employed in consideration of easy view.

Normally, with reference to a completed flowchart by an addition of a new object, an adjustment operation is performed for the purpose of appearance such as an arrangement of indentation with respect to other objects or spacing for easy view of a user. In software that draws and edits objects of the flowchart, the appearance adjustment operation is essential, which demands a lot of work time in spite of a secondary operation.

Further, the technique disclosed in PTL 2 is a technique made in consideration of an arrangement of connection lines having a form determined by a tool. However, it is necessary that a user drawing a flowchart views the entire form of the flowchart and readjusts the positions of objects in addition to the connection lines by a manual operation.

That is, in a case where an object is added, it is necessary that the user personally adjusts the entire form of the flowchart, which demands work time.

An object of the invention is to provide a flowchart drawing apparatus, a flowchart drawing method and a program that are capable of enhancing editing efficiency in drawing of a flowchart.

### Solution to Problem

According to an aspect of the invention, there is provided a flowchart drawing apparatus including a storage unit that stores part information (part information table) including coordinate information that indicates display positions of nodes and a connector that is a connection line that connects the nodes and information about connection of the nodes and the connector. Further, if an input of information relating to a node to be added to the flowchart is received from an input apparatus, the flowchart drawing apparatus determines whether a display position of the input node and the display position of the connector that forms the flowchart are overlapped with each other on the basis of the part information. Further, in a case where it is determined that the input node and the connector are overlapped with each other, the flowchart drawing apparatus determines a connection relationship between the nodes so that the input node is inserted between an upper node and a lower node connected to the overlapped connector. Further, the flowchart drawing apparatus determines display positions of the nodes and the connectors that form the flowchart, with reference to a display position of the upper node, and displays the flowchart on a display apparatus.

### Advantageous Effects of Invention

According to the invention, it is possible to provide a flowchart drawing apparatus, a flowchart drawing method and a program that enhance editing efficiency in drawing of a flowchart.

### BRIEF DESCRIPTION OF DRAWINGS

FIG. 1 is a functional block diagram illustrating a configuration example of a flowchart drawing apparatus according to an embodiment of the invention.

FIG. 2 is a diagram illustrating a state where an existing flowchart is displayed on a display apparatus by the flowchart drawing apparatus according to the embodiment.

FIG. 3 is a diagram illustrating an example of a data configuration of a part information table according to the embodiment.

FIG. 4 is a flowchart illustrating the flow of a flowchart drawing process (resultative connection) performed by the flowchart drawing apparatus according to the embodiment.

FIG. 5 is a diagram illustrating an example of a flowchart in the course of the flowchart drawing process (resultative connection) according to the embodiment.

FIG. 6 is a diagram illustrating an example of a data configuration of the part information table according to the embodiment.

FIG. 7 is a diagram illustrating an example of a data configuration of the part information table according to the embodiment.

FIG. 8 is a diagram illustrating an example of a flowchart in the course of the flowchart drawing process (resultative connection) according to the embodiment.

FIG. 9 is a diagram illustrating an example of a flowchart that is a process result of the flowchart drawing process (resultative connection) according to the embodiment.

FIG. 10 is a flowchart illustrating the flow of a display position adjustment process (resultative connection) of the flowchart drawing apparatus according to the embodiment.

FIG. 11 is a diagram illustrating an example of a data configuration of the part information table according to the embodiment.

FIG. 12 is a diagram illustrating an example of a flowchart in the course of the display position adjustment process (resultative connection) according to the embodiment.

FIG. 13 is a diagram illustrating an example of a data configuration of the part information table according to the embodiment.

FIG. 14 is a diagram illustrating an example of a flowchart in the course of a flowchart drawing process (parallel connection) according to the embodiment.

FIG. 15 is a flowchart illustrating the flow of the flowchart drawing process (parallel connection) performed by the flowchart drawing apparatus according to the embodiment.

FIG. 16 is a diagram illustrating an example of a data configuration of the part information table according to the embodiment.

FIG. 17 is a diagram illustrating an example of a flowchart in the course of the flowchart drawing process (parallel connection) according to the embodiment.

FIG. 18 is a flowchart illustrating the flow of a display position adjustment process (parallel connection) of the flowchart drawing apparatus according to the embodiment.

FIG. 19 is a diagram illustrating an example of a data configuration of the part information table according to the embodiment.

FIG. 20 is a diagram illustrating an example of a flowchart in the course of the display position adjustment process (parallel connection) according to the embodiment.

FIG. 21 is a diagram illustrating an example of a flowchart that is a process result of the display position adjustment process (parallel connection) according to the embodiment.

FIG. 22 is a diagram illustrating a data configuration of the part information table according to the embodiment.

FIG. 23 is a diagram illustrating an example of a flowchart in the course of a node group shaping process according to the embodiment.

FIG. 24 is a diagram illustrating an example of a data configuration of the part information table according to the embodiment.

FIG. 25 is a diagram illustrating an example of a flowchart in the course of the node group shaping process according to the embodiment.

FIG. 26 is a flowchart illustrating the flow of the node group shaping process of the flowchart drawing apparatus according to the embodiment.

FIG. 27 is a diagram illustrating an example of a flowchart that is a process result of the node group shaping process according to the embodiment.

### DESCRIPTION OF EMBODIMENTS

(Processing Outline)

First, a processing outline of a flowchart drawing apparatus 1 according to an embodiment of the invention will be described.

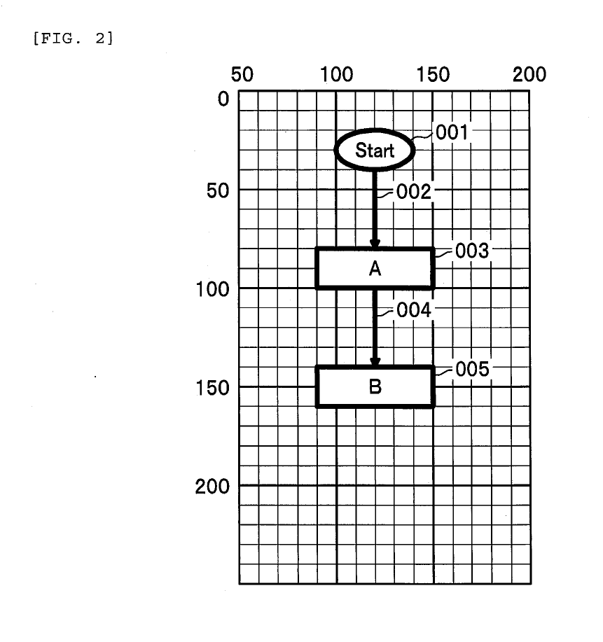

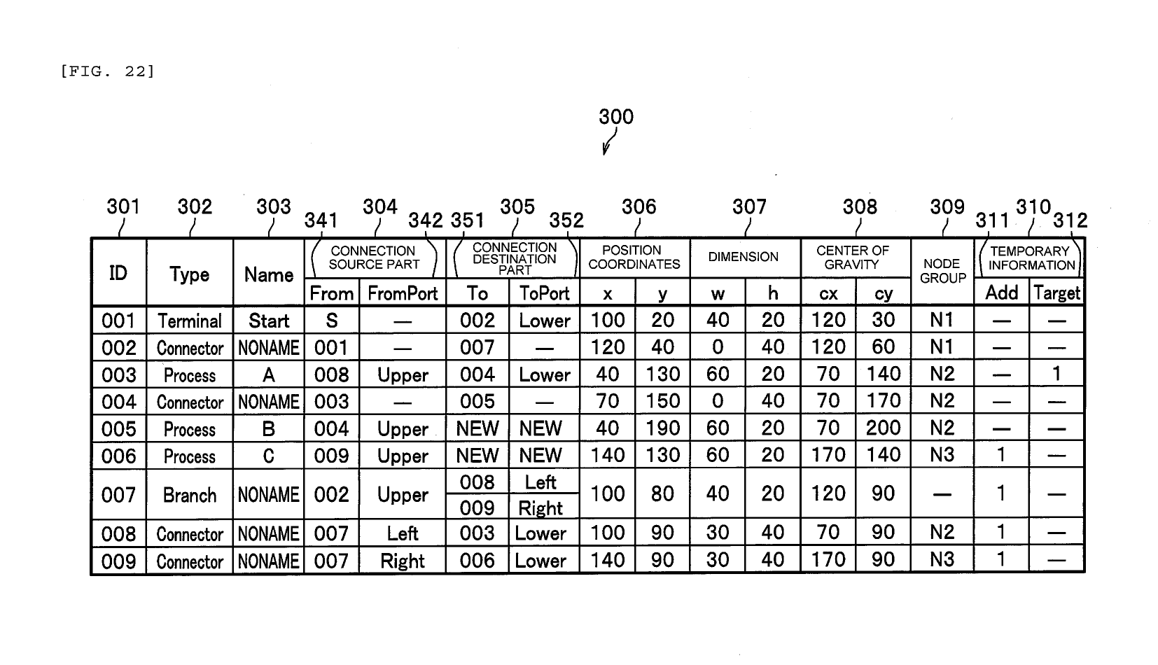

A flowchart that is processed by the flowchart drawing apparatus 1 according to the embodiment is a flowchart shown in FIG. 2, FIG. 21 or the like to be described later. The flowchart is configured by nodes indicating processes, branches or the like, and the respective nodes are connected by an arrow line (hereinafter, referred to as a “connector”). The nodes and connectors are collectively referred to as parts.

Further, the nodes include the following types.
(1) Node that indicates start and end and is displayed in an oval shape. Herein, a node that indicates start is referred to as a “start node”.
(2) Node that indicates a process and is displayed in a rectangular shape. Hereinafter, this node is referred to as a “process”.
(3) Node that indicates a branch and is displayed in a diamond shape. Hereinafter, this node is referred to as a “branch node”. In the embodiment, although not exemplified, merging of processes in the flow may be displayed in a flowchart as a diamond-shaped merging node.

The flowchart drawing apparatus 1 according to the embodiment determines arrangement of a flowchart to which a new process is added, on the basis of a connection relationship that is set in advance as a user arranges the new process in existing parts of a flowchart displayed on a display screen in an overlapping manner.

Specifically, in the user's operation for addition of the new process, execution of two connection relationship processes shown is set as follows.

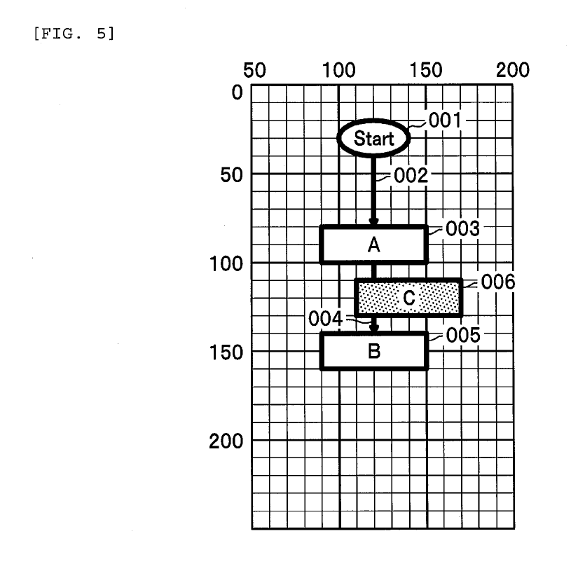

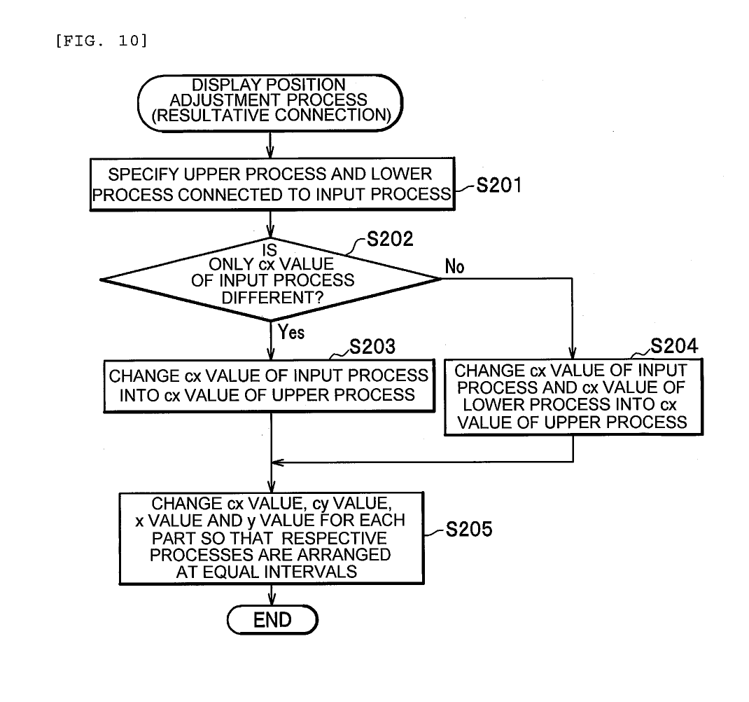

First, in a case where a flowchart shown in FIG. 2 is displayed, as shown in FIG. 5, a new process C 006 is arranged by a user so as to be overlapped with a connector (arrow) 004 between a process A 003 and a process B 005. Then, the flowchart drawing apparatus 1 according to the embodiment determines that a process of inserting the new process C 006 between the process A 003 and the process B 005 is to be performed, as shown in FIG. 9 to be described later, and then executes the process. In this way, a process of inserting a new process between nodes connected from an upper side of the flow to a lower side thereof, or such a connection relationship between nodes is referred to as a “resultative connection”, hereinafter.

Further, as shown in FIG. 14(a), the new process C 006 may be arranged by the user so as to be overlapped with the existing process (process A 003). Then, the flowchart drawing apparatus 1 according to the embodiment determines that a process of connecting the new process C 006 and the existing process A 003 in parallel is performed, as shown in FIG. 21 to be described later, and then adds a branch node (branch node 007) as a new node and connects the existing process (process A 003) and the new process C 006 in parallel. In this way, a process of branching the flow under a certain condition and connecting one process of branch destinations and the other process thereof in parallel, or such a connection relationship between nodes is referred to as a “parallel connection”, hereinafter.

The flowchart drawing apparatus 1 according to the embodiment executes a process of defining the connection relationship of a flowchart in advance in accordance with a user's operation to set a newly input process as a “resultative connection” or a “parallel connection”. In this way, a user is capable of improving working efficiency without necessity of personally changing an arrangement of existing processes in a case where the user performs an input of a new process.

Further, the flowchart drawing apparatus 1 automatically performs overall shaping according to the size of the existing parts after the connection of the newly input process ends. In this way, the user does not necessarily minutely adjust the layout of the added parts in consideration of balance with the existing parts (details will be described later).

(Configuration of Flowchart Drawing Apparatus)

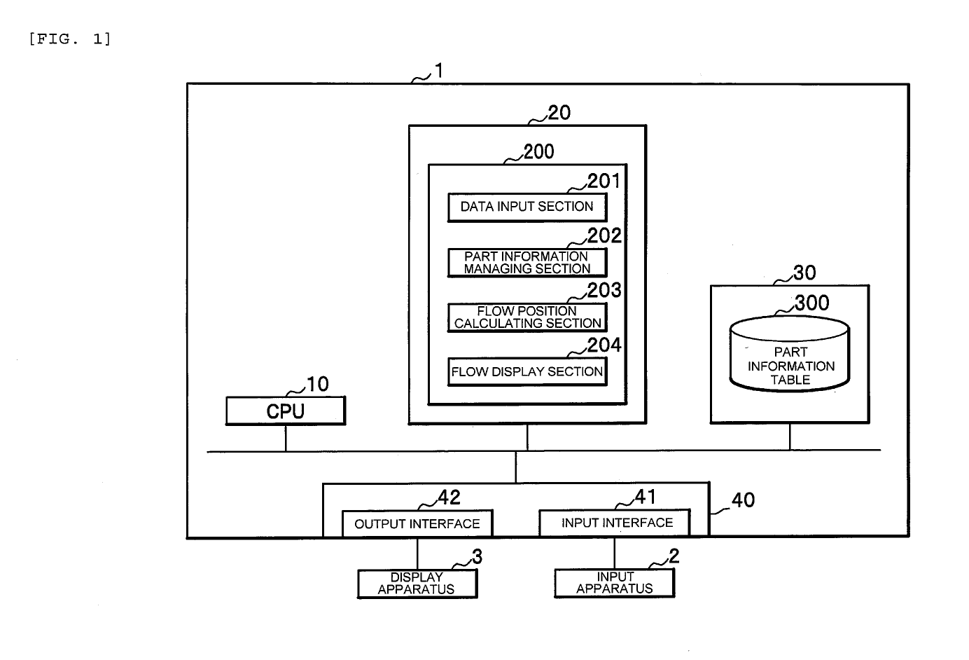

FIG. 1 is a functional block diagram illustrating a configuration example of the flowchart drawing apparatus 1 according to the embodiment. As shown in FIG. 1, the flowchart drawing apparatus 1 includes a CPU (Central Processing Unit) 10, a memory 20, a storage unit 30, and an input and output unit 40.

The CPU 10 performs overall control and calculation of the flowchart drawing apparatus 1.

Further, the input and output unit 40 includes an input interface 41 and an output interface 42. Further, the input and output unit 40 receives an input of information from an input device 2 such as a mouse or keyboard through the input interface 41. Further, the input and output unit 40 displays a flowchart that is a process result of the flowchart drawing apparatus 1 on a display or the like of a display apparatus 3, through the output interface 42.

The input interface 41 may be connected to a portable storage apparatus (not shown). That is, if a portable storage apparatus that stores a program that causes a flowchart drawing section 200 (described later) to be executed is connected to the input interface 41, the program may be transferred to the storage unit 30, or may be directly stored in the memory 20.

The storage unit 30 includes storage means such as a flash memory or a hard disk, and stores a part information table 300 or the like.

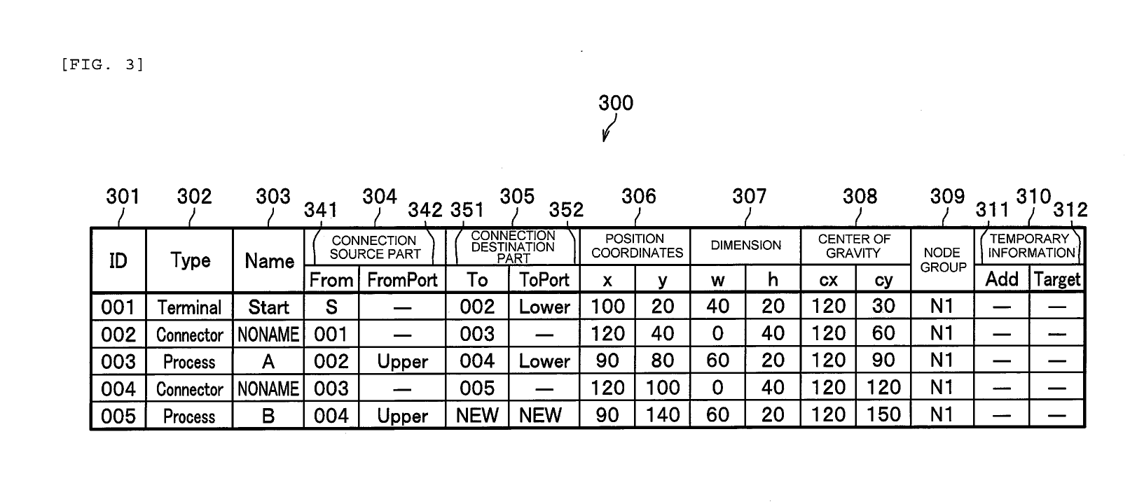

FIG. 3 is a diagram illustrating an example of a data configuration of the part information table (parts information) 300 according to the embodiment. Data in the part information table 300 shown in FIG. 3 represents information relating to the respective parts of the flowchart shown in FIG. 2.

The part information table 300 includes ID 301, Type 302, Name 303, Connection source part 304, Connection destination part 305, Position coordinates 306, Dimension 307, Center of gravity 308, Node group 309, and Temporary information 310. Information about Connection source part 304 and Connection destination part 305 corresponds to connection information in claims. Further, information about Position coordinates 306, Dimension 307 and Center of gravity 308 correspond to coordinate information that indicates a display position in claims.

ID 301 is an identifier that is uniquely given to each part of the flowchart that is a target.

Type 302 indicates the type of each part. In Type 302, “Terminal” that indicates a start node or the like, “Connector” that indicates a connector (arrow), “Process” that indicates a process, “Branch” that indicates a branch node (not shown), and the like are stored.

Name 303 represents a name of each part. Ina case where the name of the part is not given, “NONAME” is stored.

Connection source part 304 includes information about From 341 and FromPort 342. In From 341, an ID number (ID 301) of a part that is a connection source that is connected to an upper side of each part is stored. In a case where the part corresponds to a process, FromPort 342 represents that a rectangle of the process on a display screen is connected to a connector that is a connection source at a certain position on an upper side (Upper), a lower side (Lower), a left side (Left) or a right side (Right). For example, in the case of the process A 003 in which ID 301 is “003”, as shown in FIG. 2, a rectangle that indicates the process A 003 is connected to a connector 002 (ID “002”) on an upper side (Upper) of the rectangle.

Connection destination part 305 includes information about To 351 and ToPort 352. An ID number (ID “301”) of apart that is a connection destination to be connected to a lower side of the part is stored in “To” 351. In a case where the part corresponds to a process, ToPort 352 represents that a rectangle of the process on the display screen is connected to a connector that is a connection destination at a certain position on an upper side (Upper), a lower side (Lower), a left side (Left) or a right side (Right). For example, in the case of the process A 003 in which ID 301 is “003”, as shown in FIG. 2, a rectangle that indicates the process A 003 is connected to a connector 004 (ID “004”) on a lower side (Lower) of the rectangle. In a case where the type of the part is a branch node (Branch), a plurality of connectors is set to Connection destination part 305 (details will be described later).

In a case where the part corresponds to a node, Position coordinates 306 represent coordinates (x value, y value) of the upper left end of a minimum rectangle that surrounds the node. For example, Position coordinates 306 of a start node 001 in which ID 301 is “001” represent coordinates (100, 20) of the upper left end of a minimum rectangle that surrounds an oval that represents the start node 001 (see FIG. 2). Further, in a case where the part corresponds to a connector, Position coordinates 306 represent a start point of an arrow of the part that is a connection source. For example, Position coordinates 306 of the connector 004 in which ID 301 is “004” represent coordinates (120, 100) that correspond to a start point of an arrow of the connector 004 (see FIG. 2).

Dimension 307 represents the width (w value) and the height (h value) of a part. In the present example, the width (w value) of a process (rectangle) is set to “60” and the height (h value) thereof is set to “20”. The width (w value) of a connector (arrow) is set to “0” and the height (h value) thereof is set to “40”. The width (w value) of a branch node (diamond shape) is set to “40” and the height (h value) thereof is set to “20”, but Dimension 307 that represents a basic dimension of each part may be arbitrarily set.

Center of gravity 308 represents an x coordinate (cx value) and a y coordinate (cy value) of the center of gravity of each part.

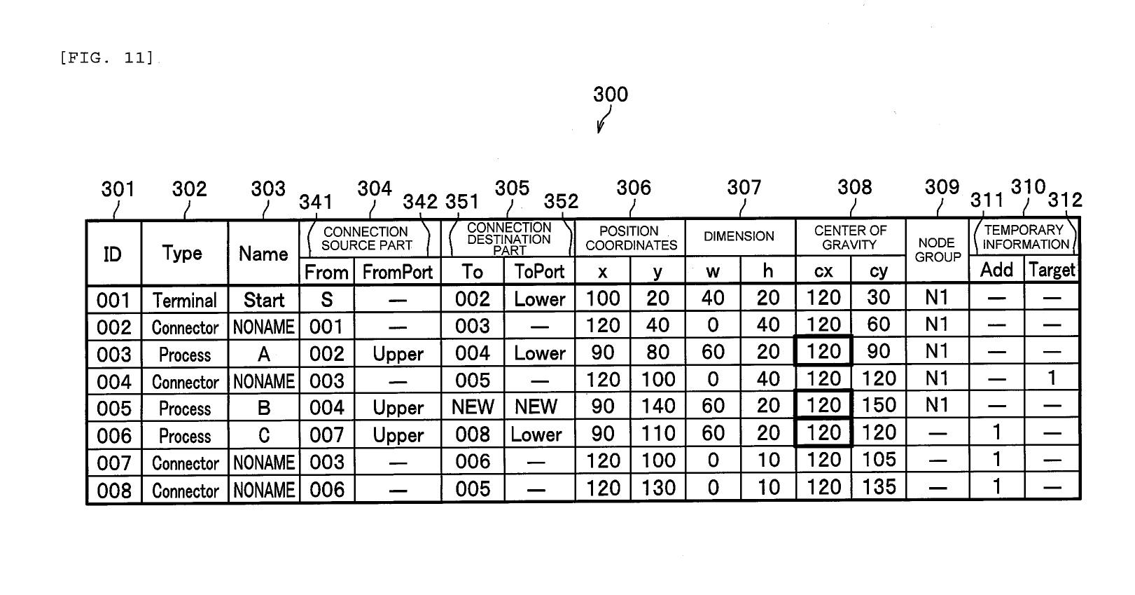

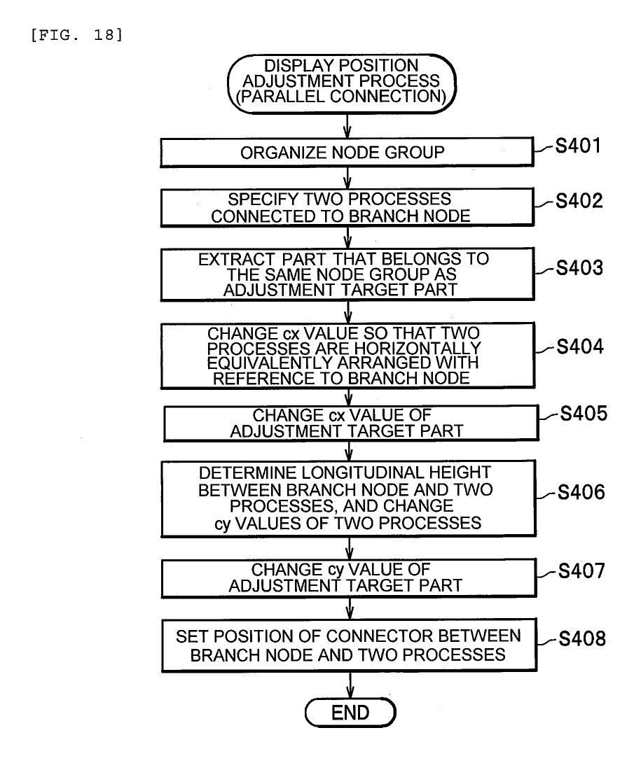

Node group 309 represents a set of parts in which a branch node or a merge node is used as a boundary. A display position adjustment process (see FIG. 10 or 18) of a flowchart to be described later is performed for parts in the same Node group 309 (details will be described later). In the flowchart shown in FIG. 2, since a branch node and a merge node are not present, “N1” that is in the same Node group 309 is set with respect to each part.

A merge node that indicates merging of a plurality of flows may not be shown in the flowchart as a diamond shaped node (the flow merging may be indicated by only arrows), but even in this case, when a plurality of connection source parts is set to the item of Connection source part 304 of the part information table 300 in the embodiment, an organization process of Node group 309 may be performed on the assumption that a virtual merge node is present.

Temporary information 310 includes information about Add 311 and Target 312. Add 311 corresponds to Temporary information 310 that indicates a node that is additionally input to a flowchart. Further, Target 312 corresponds to

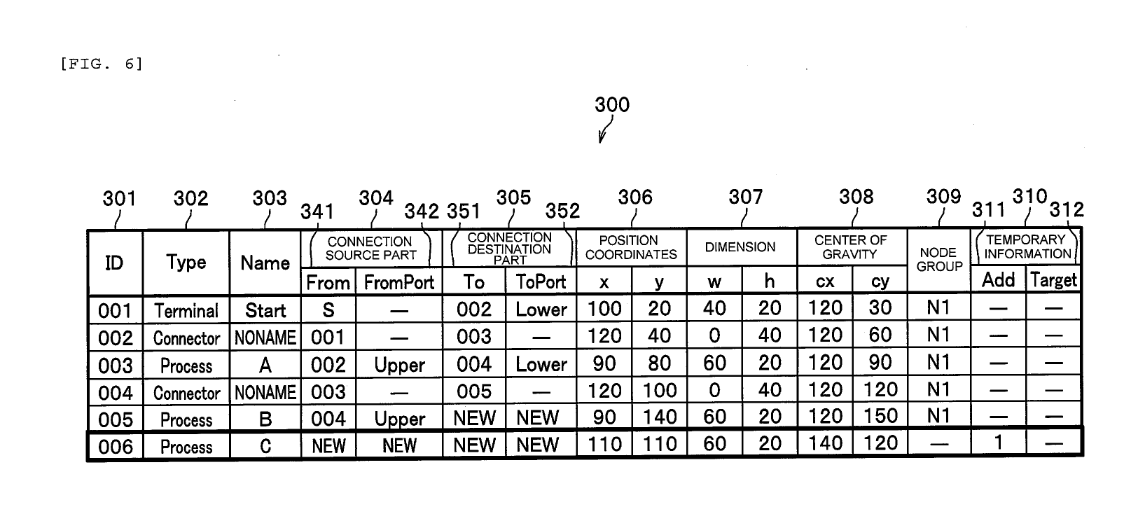

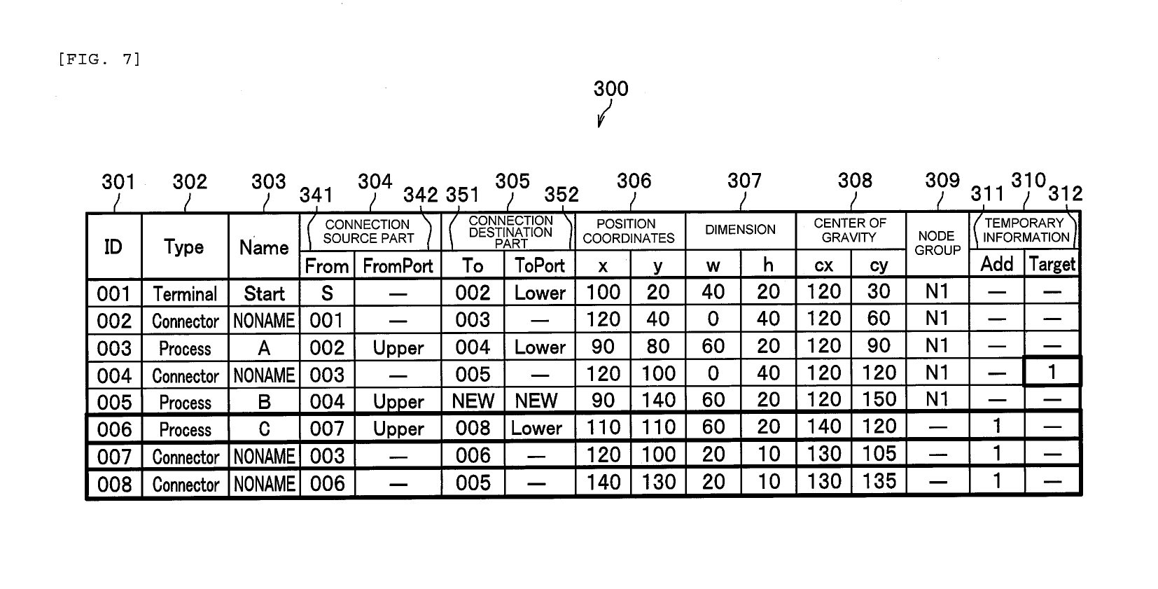

Temporary information 310 that indicates a part overlapped with the node that is additionally input to the flowchart. Temporary information 310 will be described in detail with reference to FIGS. 6 and 7 to be described later.

Returning to FIG. 1, the memory 20 includes a primary storage apparatus such as a RAM (Random Access Memory). The flowchart drawing section 200 is included in the memory 20 as a program.

The flowchart drawing section 200 performs an overall control of the flowchart drawing apparatus 1, and includes a data input section 201, a part information managing section 202, a flow position calculating section 203, and a flow display section 204. The flowchart drawing section 200 is realized by expanding a program stored in the storage unit 30 of the flowchart drawing apparatus 1 to the memory 20 and executing the program by the CPU 10, for example. Further, the flowchart drawing section 200 may be realized by hardware such as an integrated circuit or the like.

The data input section 201 receives an input of a part that is newly added through the input and output unit 40 by an operation of the input apparatus 2 by a user. Further, the data input section 201 outputs information about the received part to the part information managing section 202.

The part information managing section 202 stores the information about the input part in the part information table 300 in the storage unit 30 as Temporary information 310.

Further, the part information managing section 202 determines whether the input part corresponds to a process, and arrangement of the process is overlapped with a connector or a process that is an existing part stored in the part information table 300.

Further, in a case where the input process is overlapped with the existing connector, the part information managing section 202 determines that the “resultative connection” of inserting the input process between nodes is to be executed, and newly sets a connector for connecting the input process to a process located on an upper side of the input process and a connector for connecting the input process to a process located on a lower side thereof in the part information table 300.

Further, in a case where the input process is overlapped with the existing process, the part information managing section 202 determines that the “parallel connection” of connecting the input process and the overlapped existing process in parallel is to be executed. Further, the part information managing section 202 sets a branch node in the part information table 300, and then connects the overlapped process and the newly input process in parallel.

In a case where the part information managing section 202 determines that the resultative connection is to be executed, the position calculating section 203 specifies an upper process and a lower process to be connected to the input process, changes an X coordinate of the input process on the basis of the position coordinates of the upper process, and changes a Y coordinate so that respective processes are arranged at equal intervals. Details thereof will be described in the display position adjustment process (resultative connection) shown in FIG. 10.

Further, in a case where the part information managing section 202 determines that the parallel connection is to be executed, the flow position calculating section 203 arranges parts that are to be connected to a lower side of the branch node to be horizontally symmetric with reference to the branch node. Details thereof will be described in the display position adjustment process (parallel connection) shown in FIG. 18.

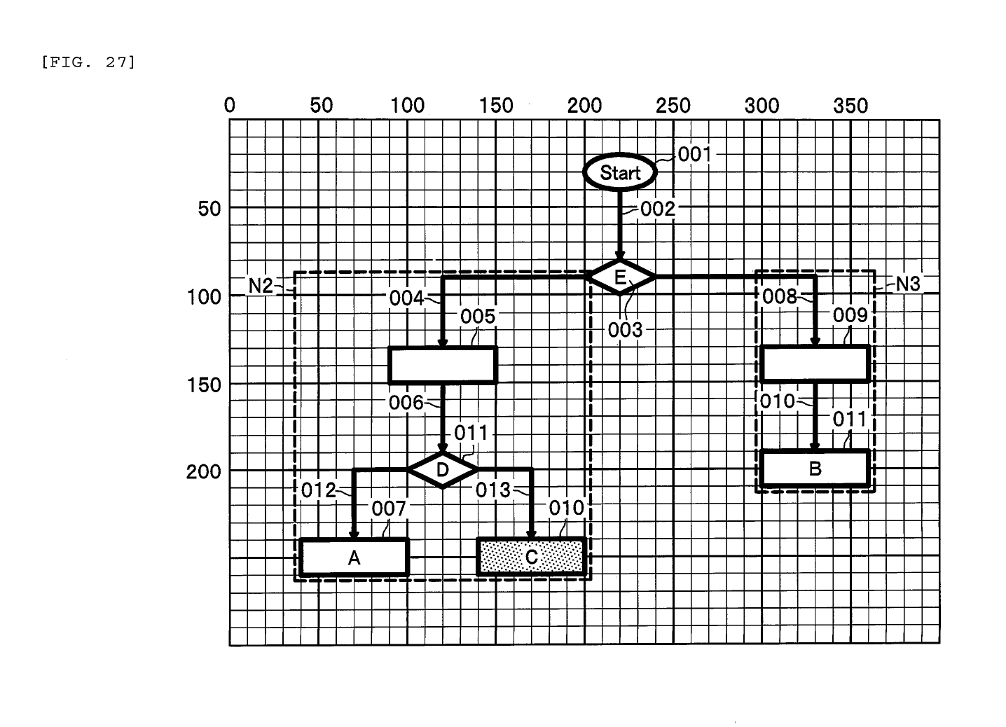

Further, if the display position adjustment process in the node group to which the input process belongs is terminated, the flow position calculating section 203 performs a node group shaping process. In the node group shaping process, the flow position calculating section 203 sets respective node groups to be horizontally symmetric so that the respective node groups are not overlapped with each other, using the branch node that is the reference as a support point. Details thereof will be described in the node group shaping process shown in FIG. 26.

The flow display section 204 acquires information about a flowchart stored in the part information table 300 through the part information managing section 202, outputs the information about the flowchart to the display apparatus 3 through the input and output unit 40, and displays the result on the display apparatus 3.

(Flowchart Drawing Process)

Next, a flowchart drawing process performed by the flowchart drawing apparatus 1 according to the embodiment will be described.

<<Resultative Connection>>

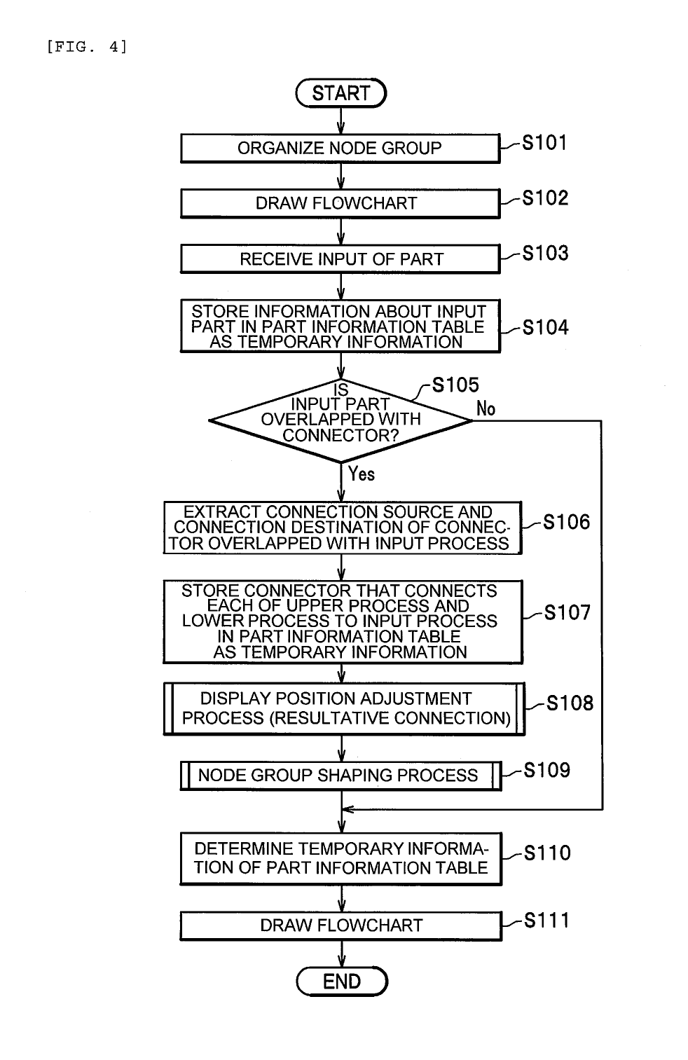

FIG. 4 is a flowchart illustrating the flow of a flowchart drawing process (resultative connection) performed by the flowchart drawing apparatus 1 according to the embodiment. In the embodiment, as shown in FIG. 5, it is assumed for description that the process C 006 is arranged on the connector (arrow) 004 of the flowchart shown in FIG. 2 and the flowchart drawing apparatus 1 performs the resultative connection process.

First, the part information managing section 202 of the flowchart drawing apparatus 1 performs organization of Node group 309 in the part information table 300 (step S101). Specifically, the part information managing section 202 groups Node group 309 in the part information table 300 using a branch or merge node as a boundary. In the present example, as shown in the part information table 300 in FIG. 3, all parts belong to the same node group (N1).

Next, the flow display section 204 of the flowchart drawing apparatus 1 acquires information about the part information table 300, and outputs a flowchart to the display apparatus 3 for drawing (step S102). Here, the displayed flowchart is a flowchart before being edited by a user, and is displayed as shown in FIG. 2.

Subsequently, the data input section 201 receives an input of a newly added part through the input and output unit 40 by an operation of the input apparatus 2 by the user (step S103). Specifically, the data input section 201 receives an input of the process C 006 (see FIG. 5).

Further, the part information managing section 202 stores information about the input part, here, information about the process C 006 in the part information table 300 as Temporary information 310 (step S104). Specifically, as shown in FIG. 6, the process C 006 is added to the part information table 300. Here, the part information managing section 202 stores ID 301 (“006”), TYPE 302 (“Process”), and Name 303 (“C”) from information about a display position where the process C 006 is added by the user, and calculates and stores information about Position coordinates 306, Dimension 307 and Center of gravity 308. Further, the part information managing section 202 sets a value “NEW” that indicates that a connection destination and a connection source are not determined, with respect to Connection source part 304 and Connection destination part 305 that are not determined yet. Further, the part information managing section 202 sets “1” as Add 311 of Temporary information 310, in order to indicate that the input information is information (temporary information) about all the parts before adjustment of display positions.

Next, the part information managing section 202 determines whether the part input by the user in step S103 is a process and is overlapped with a connector that is an existing part (step S105). Here, the overlap means that the newly added process and the existing part are displayed on a display of the display apparatus 3 to be overlapped with each other. As shown in FIG. 5, the process C 006 input by the user is displayed to be overlapped with the connector 004 that is the existing part. In this way, when a new process is added according to a user's operation, addition of the process to an existing connector in an overlapping manner means that the added process is inserted between an upper process and a lower process that are connected to the connector.

In step S105, in a case where the input part corresponds to the process and is overlapped with the existing connector (step S105−>Yes), the procedure goes to step S106. On the other hand, in a case where the input part is not the process or in a case where the input part is not overlapped with the existing connector even in a case where the input part is the process (step S105−>No), the procedure goes to step S110.

Next, in step S106, the part information managing section 202 extracts processes of a connection source and a connection destination of the connector overlapped with the input process, and determines a connection relationship thereof. Here, the part information managing section 202 extracts the respective processes of the connection source and the connection destination of the connector 004 overlapped with the input process C 006 from the items of From 341 and To 351 of the part information table 300, and obtains the process A 003 as the connection source and obtains the process B 005 as the connection destination.

Further, the part information managing section 202 sets a connector that connects each of the upper process (process that is the extracted connection source) of the input process and the lower process (process that is the extracted connection destination) thereof and the input process, and stores the result in the part information table 300 as Temporary information 310 (step S107).

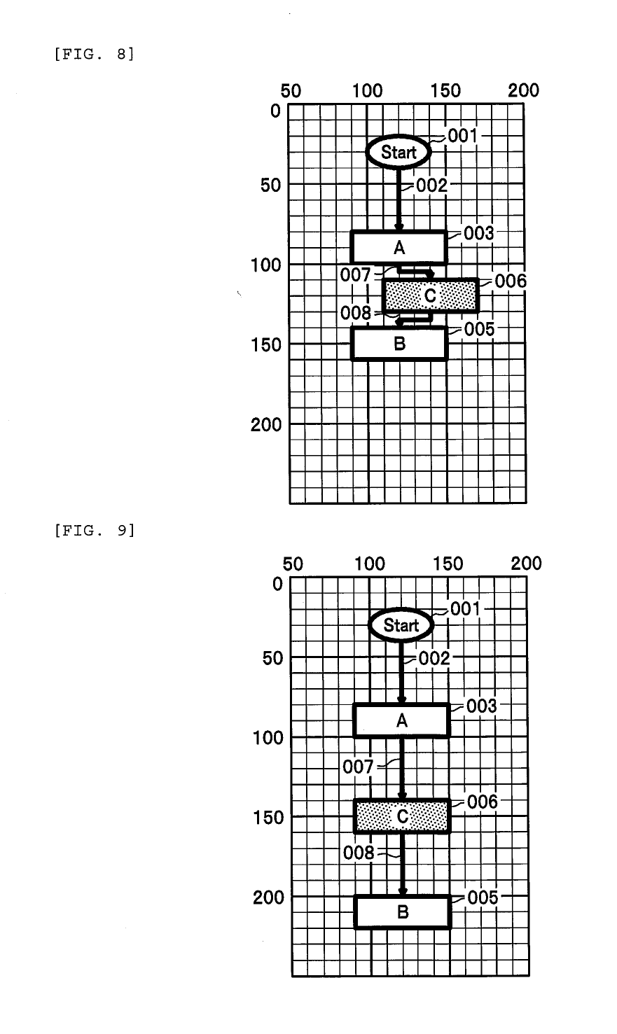

The process of step S107 will be specifically described using the part information table 300 shown in FIG. 7. The part information managing section 202 sets “1” as Target 312 of Temporary information 310 of the connector 004 that is the part overlapped with the process C 006 that is input by the user, in the part information table 300. Next, the part information managing section 202 adds a connector 007 between the process C 006 and the process A 003, and adds a connector 008 between the process C 006 and the process B 005, as new connectors. Further, the part information managing section 202 sets “1” as Add 311 of Temporary information 310 about the connector 007 and the connector 008. The flowchart in a state where the process of step S107 is terminated is shown for description similar to FIG. 8.

Returning to FIG. 4, next, the flow position calculating section 203 of the flowchart drawing apparatus 1 adjusts display positions of all the parts in the node group (N1) including the newly added process and connectors (step S108). The result of the position adjustment of the flowchart in step S108 is shown in FIG. 9. Details of the display position adjustment process (resultative connection) of the flowchart will be described in FIG. 10.

Subsequently, the flow position calculating section 203 performs the node group shaping process (step S109). The node group shaping process is performed in a case where a plurality of node groups is present in the item of Node group 309 in the part information table 300. Here, since only one node group of “N1” is present, the node group shaping process is not performed, and thus, the node group shaping process will be described later (see FIG. 26).

Further, in the flowchart drawing apparatus 1, if the display position of the flowchart is determined in step S108 and step S109, the part information managing section 202 determines Temporary information 310 of the part information table 300 (step S110). Specifically, the determination of Temporary information 310 in the part information managing section 202 is to perform a delete process of the values set in Add 311 and Target 312 of Temporary information 310 of the part information table 300. Then, the flow display section 204 draws the determined flowchart on the display of the display apparatus 3 through the input and output unit 40 (step S111).

<Display Position Adjustment Process (Resultative Connection)>

Next, the display position adjustment process (resultative connection) in step S108 in FIG. 4 will be described with reference to FIG. 10. FIG. 10 is a flowchart illustrating the flow of the display position adjustment process (resultative connection) performed by the flowchart drawing apparatus 1 according to the embodiment.

First, the flow position calculating section 203 of the flowchart drawing apparatus 1 specifies an upper process and a lower process connected to an input process (step S201). Specifically, first, the flow position calculating section 203 searches an upper process that is in the connection relationship with the input process C 006 from the part information table 300. Here, the flow position calculating section 203 extracts, if the upper part is the connector 007 in which an ID number is “007”, the upper part from the item of From 341 of Connection source part 304 of the process C 006 in the part information table 300 in FIG. 7, and specifies that the part located on the upper side of the connector 007 is the process A 003 from the item of From 341 of Connection source part 304 of the connector 007. Similarly, with reference to a lower process that is in the connection relationship with the process C 006, the flow position calculating section 203 extracts, if the lower part is the connector 008 in which an ID number is “008”, the lower part from the item of To 351 of Connection destination part 305 of the process C 006. The flow position calculating section 203 specifies that the part located on the lower side of the connector 008 is the process B 005 from the item of To 351 of Connection destination part 305 of the connector 008.

Next, the flow position calculating section 203 compares a cx value that is an X coordinate of Center of gravity 308 of the upper process and the lower process that are specified in step S201 with a cx value that is an X coordinate of Center of gravity 308 of the input process, and determines whether only the cx value of Center of gravity 308 of the input process is different (step S202). Here, the cx value of the process A 003 that is the upper process and the cx value of the process B 005 that is the lower process, and the cx value of the process C 006 that is the input process are compared with each other.

Further, in a case where the cx values of the upper process and the lower process are the same and only the cx value of the input process is different therefrom (step S202−>Yes), the flow position calculating section 203 causes the procedure to go to step S203.

In step S203, the flow position calculating section 203 changes the cx value of Center of gravity 308 of the input process into the same value as the cx value of the upper process (step S203).

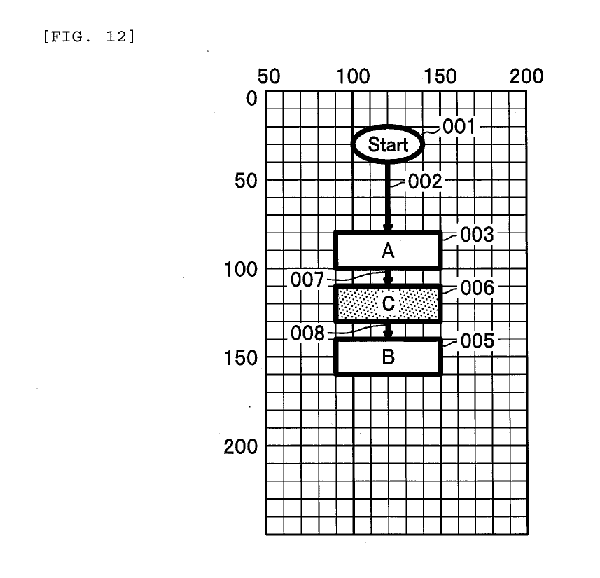

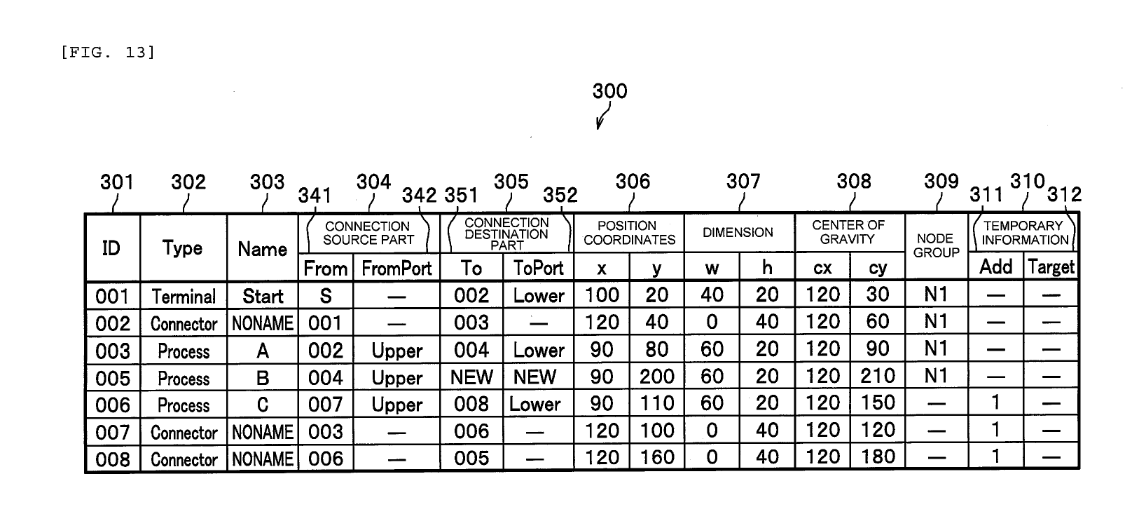

In the present example, since the cx value of the process A 003 that is the upper process and the cx value of the process B 005 that is the lower process are the same and only the cx value of the process C 006 that is the input process is different therefrom, the cx value of Center of gravity 308 of the input process is set to the same value as the cx value of the process A 003. The part information table 300 when the process of step S203 is terminated is shown in FIG. 11, and the flowchart in this state is shown in FIG. 12. As shown in FIG. 12, the cx value of Center of gravity 308 is set to the same value in the respective processes.

On the other hand, returning to FIG. 10, in step S202, the cx values of the upper process and the lower process are compared with the cx value of the input process, and in a case other than a case where only the cx value of Center of gravity 308 of the input process is different (step S202−>No), that is, in a case where the respective cx values of the upper process, the lower process and the input process are all different from each other, or in a case where the cx values of the upper process and the input process are the same and only the cx value of the lower process is different therefrom, the procedure goes to step S204.

In step S204, the flow position calculating section 203 changes the cx value of Center of gravity 308 of the input process or the cx value of Center of gravity 308 of the lower process into the same value as the cx value of Center of gravity 308 of the upper process. That is, the flow position calculating section 203 matches the cx values of the input process C 006 and the lower process B 005 with the cx value of the process A 003 that is the upper process.

Next, if the process of step S203 or step S204 is terminated, the flow position calculating section 203 changes a cx value, a cy value and an x value and a y value for each part so that respective processes are arranged at equal intervals (step S205).

Specifically, first, the flow position calculating section 203 specifies the height (h value of Dimension 307) of a connector that is not an adjustment target. In this example, the flow position calculating section 203 stores the height (h value) “40” of a connector 002 that is connected to an upper side of the upper process A 003. The flow position calculating section 203 adjusts a Y coordinate with reference to the h value “40”. Further, the flow position calculating section 203 adjusts display positions of all the parts so that the height (h value) of a newly inserted connector is “40” and the width (w value) of Dimension 307 of the connector is “0”. Further, the flow position calculating section 203 deletes a connector in which “1” is set in the item of Target 312 of Temporary information 310 of the part information table 300. Specifically, the flow position calculating section 203 deletes the connector 004 that is unnecessary as the connector 007 and the connector 008 connected to the newly added process C 006 are set.

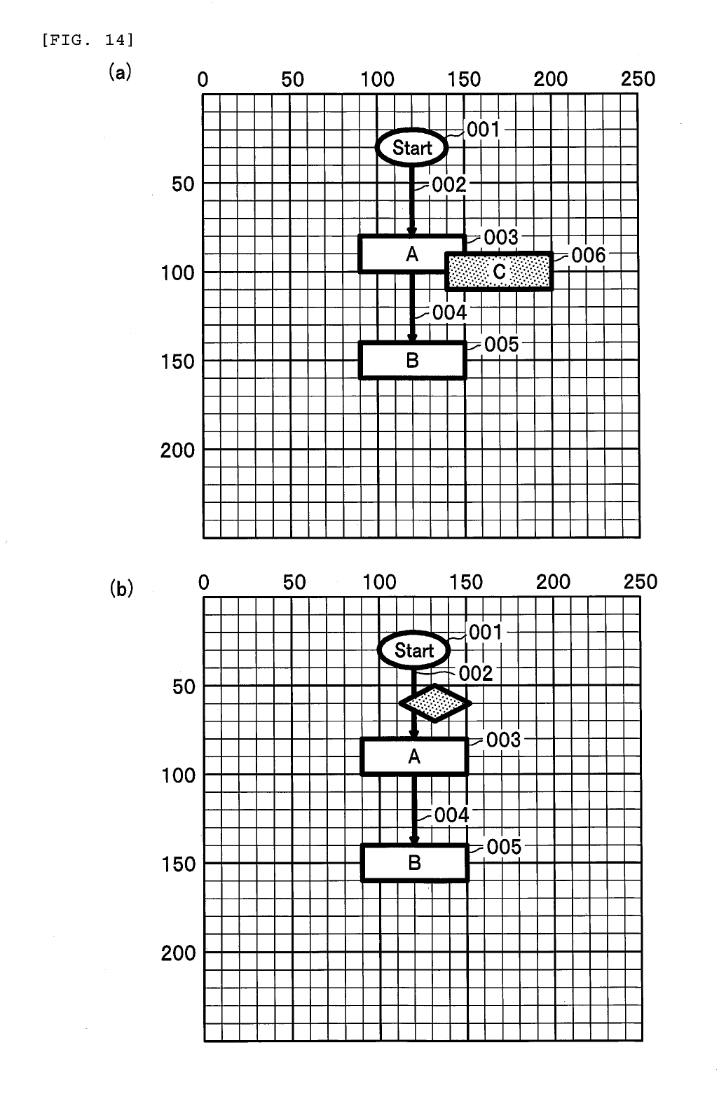

FIG. 13 shows the part information table 300 adjusted so that respective parts are arranged at equal intervals by executing step S205 in FIG. 10. In the part information table 300 shown in FIG. 13, the connector 004 is deleted. Using the part information table 300 shown in FIG. 13, a flowchart is shown as in FIG. 9. That is, the process C 006 is inserted between the process A 003 and the process B 005, and the respective processes are arranged at uniform intervals.

An adjustment principle relating to the layout of the display positions varies according to a user's preference or work that uses a flowchart. Accordingly, the display position adjustment of the flowchart illustrated in the embodiment may be stored in the storage unit 30 on the basis of a different adjustment logic so that a user can change the display positions.

With such a configuration, according to the flowchart drawing apparatus 1 of the embodiment, it is possible to specify the connection relationship of the process input by the user by overlapping of figures on the display screen, and to simplify an editing operation of the flowchart. Further, the user does not necessarily minutely adjust the layout of the added part in consideration of balance with the existing part.

<<Parallel Connection>>

Next, a flowchart drawing process (parallel connection) in a case where the flowchart drawing apparatus 1 according to the embodiment is arranged so that a process that is newly input by a user is overlapped with an existing process will be described.

In the flowchart drawing process (parallel connection), as shown in FIG. 14 (a), in a case where the newly input process (for example, process C 006) is overlapped with the existing process (for example, process A 003), the relationship where the existing process and the input process are connected with each other in parallel is regulated in the flowchart drawing apparatus 1. Further, as shown in a process result in FIG. 21, the flowchart drawing apparatus 1 draws a flow in which a branch node is added, the existing process overlapped with the input process and the input process are branched from the branch node under a certain condition, and the existing process is performed under one condition and the input process is performed under the other condition.

Hereinafter, as shown in FIG. 14(a), a case where the new process (process C 006) is overlapped with the existing process (process A 003) will be described, but as shown in FIG. 14(b), the flowchart drawing apparatus 1 may similarly perform the parallel connection process even in a case where an upper connector (connector 002) connected to the existing process (process A 003) is overlapped with the new branch node.

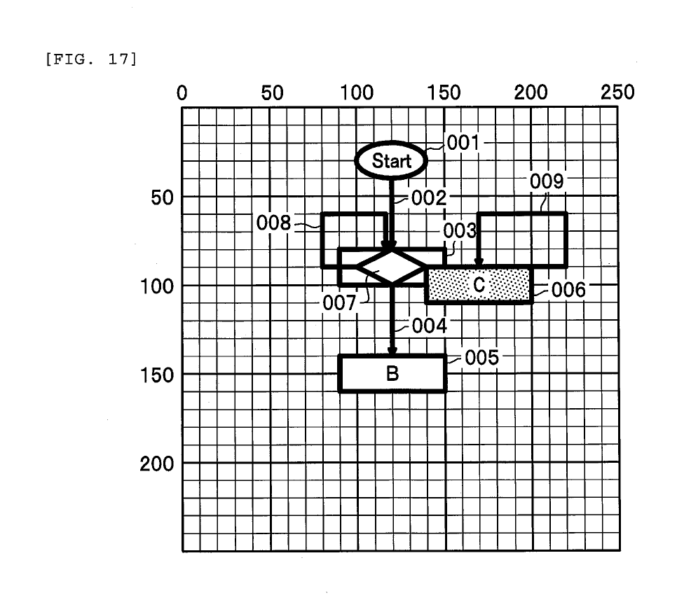

In a case where the branch node is overlapped with the upper connector 002 connected to the process A 003, the flowchart drawing apparatus 1 arranges parts of the process A 003 and thereafter on the left side of the branch node, and adds a new process on the right side of the branch node. Further, the newly input branch node is rearranged in the same Center of gravity 308 as that of the process A 003, as shown in FIG. 17 to be described later, to perform the parallel connection process to be described hereinafter, and may display a flowchart having a process result shown in FIG. 21.

In the resultative connection, the newly input part corresponds to a process and the input process is overlapped with the existing connector, and thus, the flowchart drawing apparatus 1 determines that the resultative connection process is to be performed. On the other hand, in a case where the input part is the branch node and is overlapped with the existing connector, the flowchart drawing apparatus 1 determines that the parallel connection process is to be performed. In this case, the same result as in a case where a user performs the operation shown in FIG. 14(a) is obtained.

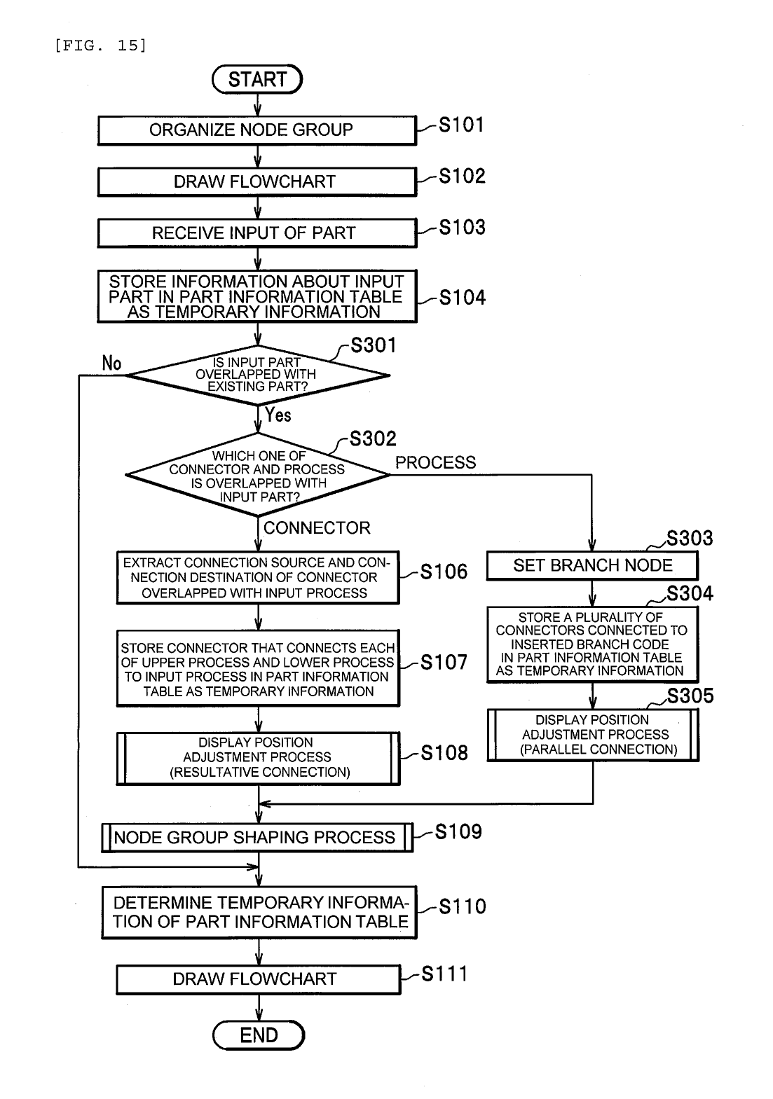

Next, the flow of the parallel connection process of the flowchart drawing apparatus 1 according to the embodiment will be described with reference to FIG. 15. The same reference numerals are given to the same processes as in the flow of the resultative connection process of the flowchart drawing apparatus 1 shown in FIG. 4, and detailed description thereof will not be repeated. Further, here, as shown in FIG. 14(a), it is assumed for description that the process C 006 is added to the flowchart shown in FIG. 2.

As shown in FIG. 15, first, in a similar way to steps S101 to S104 in FIG. 4, organization of Node group 309 and flowchart drawing are performed, and the existing flowchart is displayed on the display apparatus 3. Further, information about a part input by the user is stored in the part information table 300 as Temporary information 310. In step S103, in the resultative connection in FIG. 4, the user arranges an additional process to be overlapped with the existing connector (arrow), but in order to perform the parallel connection process, the user arranges the additional process to be overlapped with the existing process.

Next, the part information managing section 202 of the flowchart drawing apparatus 1 determines whether the input part is overlapped with the existing part (step S301). Further, in a case where the input part is not overlapped with the existing part (step S301−>No), the procedure goes to step S110. On the other hand, in a case where the input part is overlapped with the existing part (step S301−>Yes), the procedure goes to step S302. In the present example, as shown in FIG. 14(a), since the input process C 006 is overlapped with the existing process A 003, the procedure goes to step S302.

In step S302, the part information managing section 202 determines whether the part input in step S103 by the user corresponds to a process and the existing part overlapped with the input part corresponds to a connector or a process. Here, in a case where the existing part overlapped with the input process corresponds to the connector (step S302−>connector), the same processes as those of steps S106 to S108 in FIG. 4 are performed.

On the other hand, in a case where the existing part overlapped with the input process corresponds to the process (step S302−>process), the procedure goes to the parallel connection process of steps S303 to S305.

Next, the part information managing section 202 sets a branch node for connecting the overlapped process and the newly input process in parallel in the part information table 300 (step S303). In the present example, a branch node 007 for connecting the process A 003 that is a process to be overlapped and the input process C 006 in parallel is added to the part information table 300.

Subsequently, the part information managing section 202 stores a plurality of connectors to be connected to the set (inserted) branch node as Temporary information 310 in the part information table 300 (step S304). Specifically, the part information managing section 202 adds a connector 008 between the newly added branch node 007 and the process to be overlapped (process A 003), and adds a connector 009 between the branch node 007 and the newly input process (process C 006) to determine the connection relationship. Further, the part information managing section 202 changes a connector 002 connected between the process to be overlapped (process A 003) and a start node 001 into a connector that connects the branch node 007 and the start node 001.

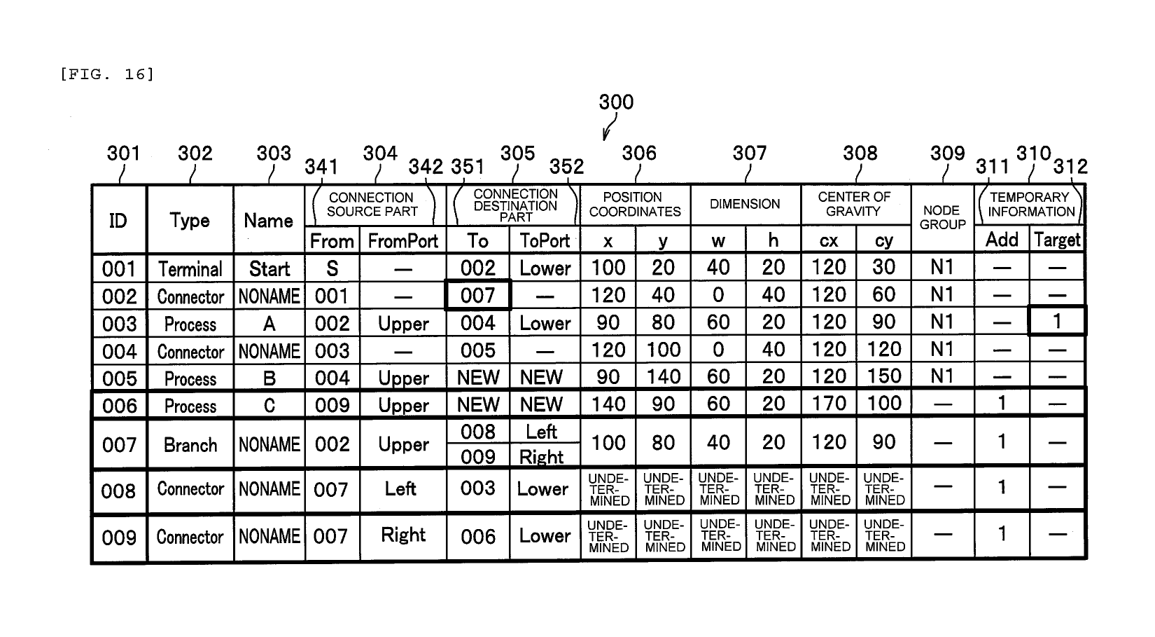

The part information table 300 at the time when the process of step S304 is terminated is shown in FIG. 16. In FIG. 16, the newly input process C 006, the branch node 007, the connector 008 and the connector 009 are newly set. Further, ID of To 351 that is a connection destination of the connector 002 is changed into “007” (branch node). Further, “1” is set in Target 312 of Temporary Information 310 of the process A 003 that is a process to be overlapped.

Here, the flow position calculating section 203 arranges an insertion position of the newly set branch node 007 to have the same Center of gravity 308 as in the process A 003 to be overlapped. Further, the newly set connector 008 and connector 009 are indicated as “undetermined” since Position coordinates 306, Dimension 307 and Center of gravity thereof are not specified. Position coordinates 306, Dimension 307 and Center of gravity 308 of the other parts including the input process C 006, the branch node 007 and the like are calculated on the basis of arrangement positions at the current time point by the flow position calculating section 203, and then are stored in the part information table 300. The part information table 300 shown in FIG. 16 is shown for description similar to FIG. 17. In FIG. 17, the newly set branch node 007 is arranged at the same Center of gravity 308 as that of the process A 003 to be overlapped. In the part information table 300 in FIG. 16, display positions of the connector 008 and the connector 009 are “undetermined”. However, in order to indicate the existence of the connector 008 and the connector 009, in FIG. 17, the connector 008 and the connector 009 are virtually displayed with the branch node 007 being a connection source and with a connection destination being an “Upper” port of each of the process A 003 and the process C 006.

Returning to FIG. 15, the flow position calculating section 203 adjusts display positions of all parts in Node group 309 including the newly input process, the branch node and the connectors (step S305). Details of the display position adjustment process (parallel connection) of the flowchart will be described with reference to FIG. 18 to be described later.

Subsequently, in a similar way to steps S109 to S111 in FIG. 4, the flowchart drawing apparatus 1 performs a shaping process of Node group 309, and draws the determined flowchart on the display of the display apparatus 3.

<Display Position Adjustment Process (Parallel Connection)>

Next, the display position adjustment process (parallel connection) in step S305 in FIG. 15 will be described with reference to FIG. 18. FIG. 18 is a flowchart illustrating the flow of the display position adjustment process (parallel connection) of the flowchart drawing apparatus 1 according to the embodiment. In the display position adjustment process (parallel connection), the flowchart drawing apparatus 1 inserts the branch node, and arranges the parts connected on the lower side of the branch node to be horizontally symmetric with reference to the branch node. Hereinafter, detailed description thereof will be made.

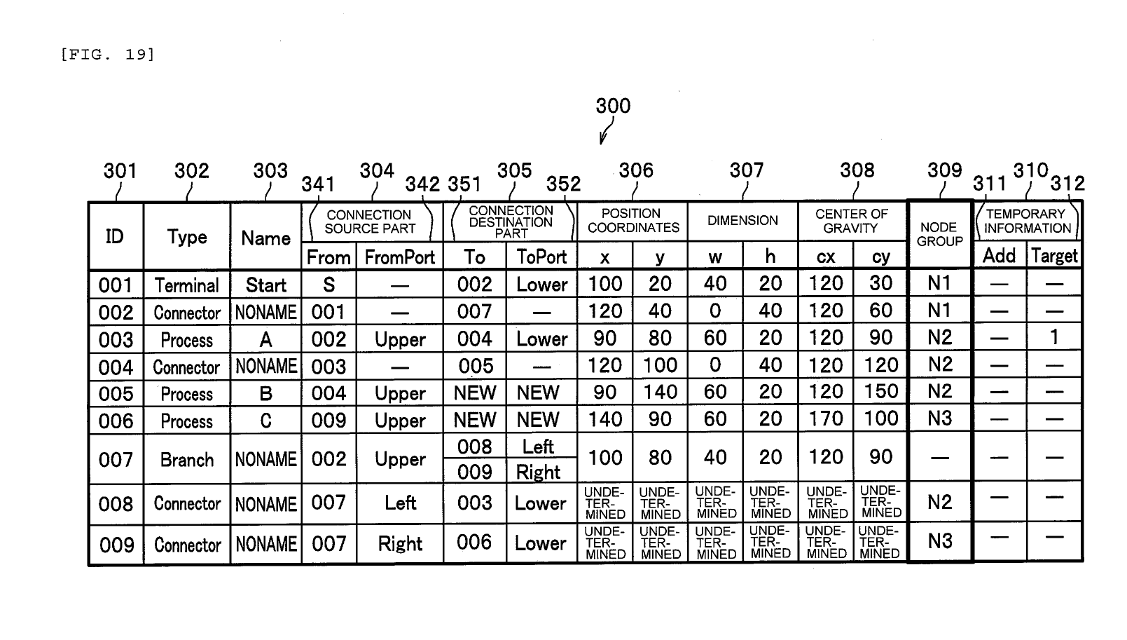

First, the part information managing section 202 performs organization of Node group 309 that includes the newly input process, the branch node and the newly set connectors (step S401). In the present example, the part information managing section 202 groups Node group 309 in the part information table 300 using the branch node 007 as a boundary. Further, as shown in FIG. 19, the part information managing section 202 sets Node group 309 to “N1” with respect to the start node 001 and the connector 002. With respect to the process A 003, the connector 004, the process B 005 and the connector 008, Node group 309 is set to “N2”. Further, with respect to the process C 006 and the connector 009, Node group 309 is set to “N3”.

Next, the flow position calculating section 203 specifies processes to be connected to the inserted branch node (step S402). In the present example, the flow position calculating section 203 specifies the process A 003 to be connected to the branch node 007 through the connector 008, and the process C 006 to be connected to the branch node 007 through the connector 009.

Next, on the basis of Node group 309 to which each process specified in step S402 belongs, a part that belongs to the same Node group 309 is specified, and is extracted as an adjustment target part (step S403). In the present example, Node group 309 to which the process A 003 belongs is “N2”, and thus, the connector 004, the process B 005 and the connector 008 that belong to the same Node group 309 are specified as the adjustment target parts. Further, Node group 309 to which the process C 006 belongs is “N3”, and thus, the connector 009 that belongs to the same Node group 309 is specified as the adjustment target part.

Next, the flow position calculating section 203 changes centers of gravity (cx values) of two processes so that two processes are arranged to be horizontally symmetric with reference to the branch node in order to determine a horizontal arrangement of the flowchart (step S404). In the present example, the flow position calculating section 203 changes the cx values so that the process A 003 and the process C 006 are respectively arranged according to positions of a left end and a right end of a diamond shape of the branch node 007 on the basis of the width (w value) of the branch node and the widths (w values) of the processes.

Subsequently, the flow position calculating section 203 changes the cx value of the adjustment target part (step S405). Specifically, the flow position calculating section 203 changes the center of gravity (cx value) of the part located on a lower side of the process specified in step S402 among the adjustment target parts specified in step S403 into the same value as the cx value of the process to be connected to an upper side thereof that is changed in step S404. In the present example, the cx values of the connector 004 and the process B 005 among the adjustment target parts of which Node group 309 is “N2” are changed into the same value as the cx value of the upper process (process A 003).

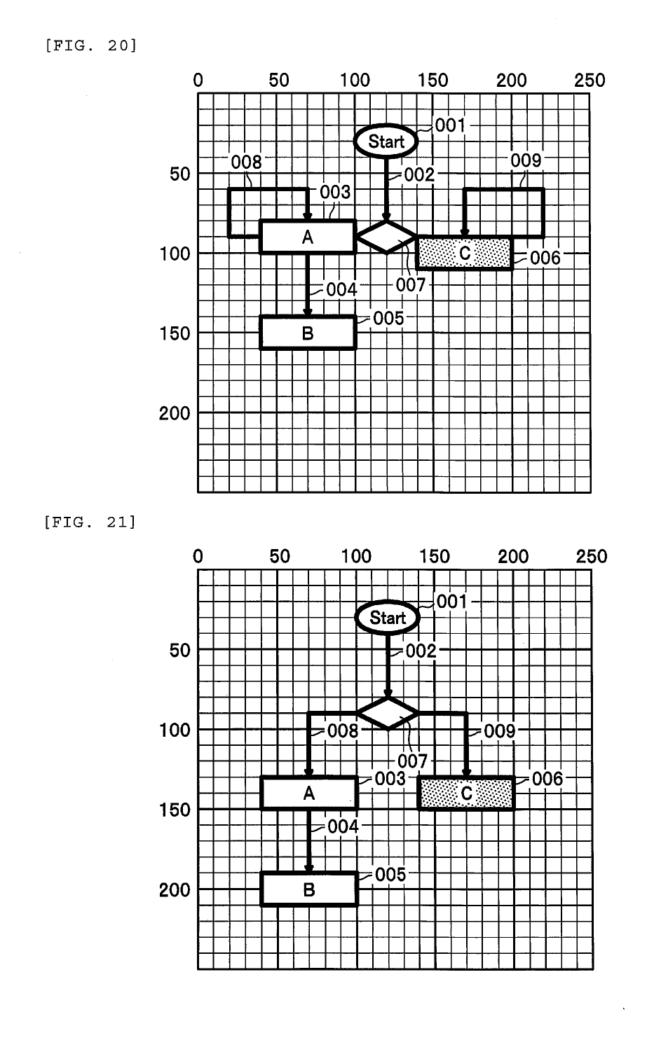

The result obtained by performing the processes up to step S405 is shown for description similar to a flowchart of FIG. 20. The centers of gravity (cx values) of the process A 003 and the process C 006 are changed to be horizontally symmetric with reference to the branch node 007. Further, the process A 003, the connector 004, the process B 005 are arranged at the same center of gravity (cx value).

Returning to FIG. 18, in step S406, the flow position calculating section 203 determines the vertical height between the branch node and two processes specified in step S402, and changes cy values of the two processes.

Specifically, the flow position calculating section 203 stores the height (h value) “40” of the connector 002 that connects the start node 001 to the process A 003. Further, the flow position calculating section 203 determines the centers of gravity (cy values) of the process A 003 and the process C 006 to be positioned on a lower side of the center of gravity (cy value) of the branch node 007 as much as a value (that is, “50”) obtained by adding the height (h value) “40” of the stored connector and a value that is ½ (here, “10”) of the height (h value) of Dimension 307 thereof.

Next, in step S407, the flow position calculating section 203 changes the cy value of the adjustment target part.

Specifically, the flow position calculating section 203 determines the center of gravity (cy value) of the part positioned on the lower side of the process specified in step S402 among the adjustment target parts specified in step S403 to be positioned on the lower side as much as “50”.

Further, the flow position calculating section 203 specifies the position of the connectors that connect two processes specified in step S402 and the branch node 007 (step S408).

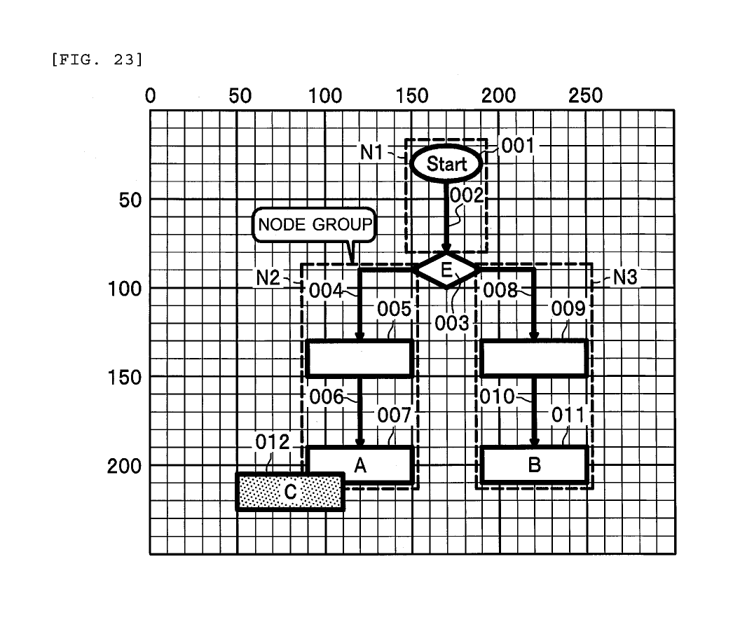

The flowchart that is the result obtained by executing the display position adjustment process (parallel connection) is shown in FIG. 21, and the part information table 300 thereof is shown in FIG. 22.

In the part information table 300 in FIG. 22, Center of gravity 308 of the connector 008 and the connector 009 that are two added connectors are set to be positioned at a corner in which a line of each connector is bent at a right angle. Thus, when a new part is added on a lower side of an existing process by a user, the flow position calculating section 203 performs calculation from the position of the corner to thereby easily perform position calculation for horizontal equivalence and vertical equivalence. Here, this is only an example, and thus, calculation values of the original centers of gravity may be set. That is, it is sufficient if the position calculation for horizontal equivalence and vertical equivalence is possible by adjusting the arrangement of the parts.

As described above, according to the flowchart drawing apparatus 1 according to the embodiment, it is possible to execute the parallel connection process as a user overlaps a new process with an existing process, and to determine a display position of a flowchart for drawing without an additional operation such as a minute adjustment with respect to the layout of each part.

<<Node Group Shaping Process>>

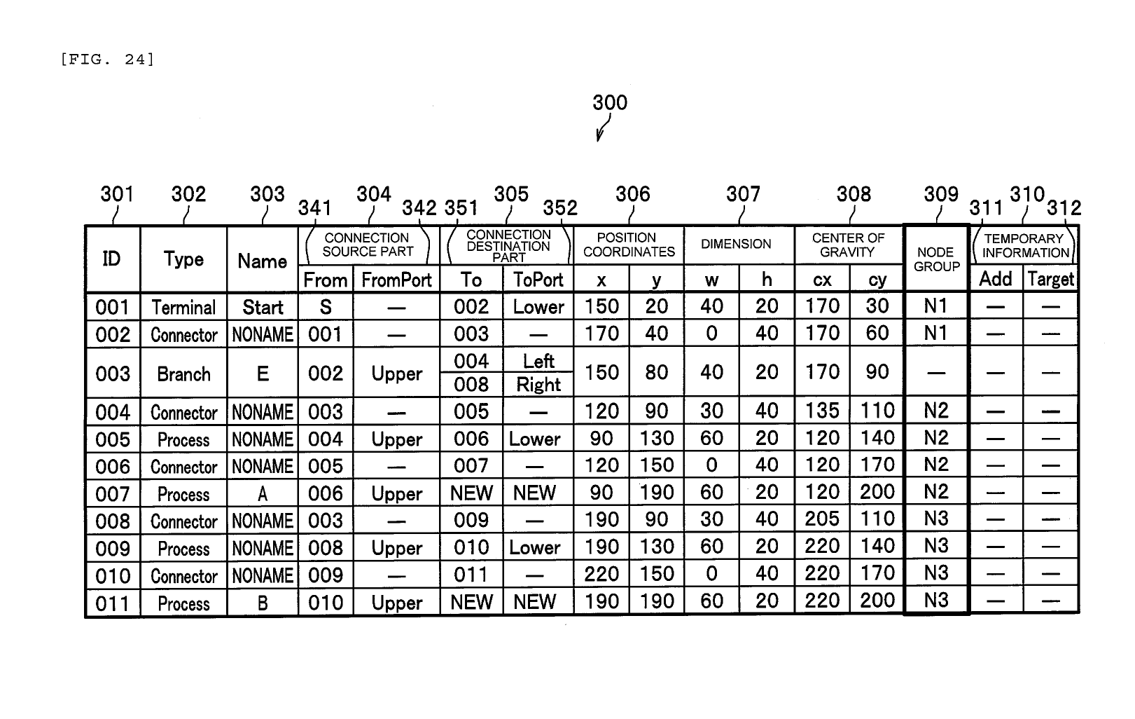

Next, the node group shaping process performed in step S109 in FIGS. 4 and 15 will be described with reference to an example in which the parallel connection process is performed in an existing flowchart including a branch node. In the present example, as shown in FIG. 23, it is assumed for description that an operation of a parallel connection in which a process C 012 is newly overlapped with a process A 007 of an existing flowchart including a branch node (branch node E 003) is performed by a user.

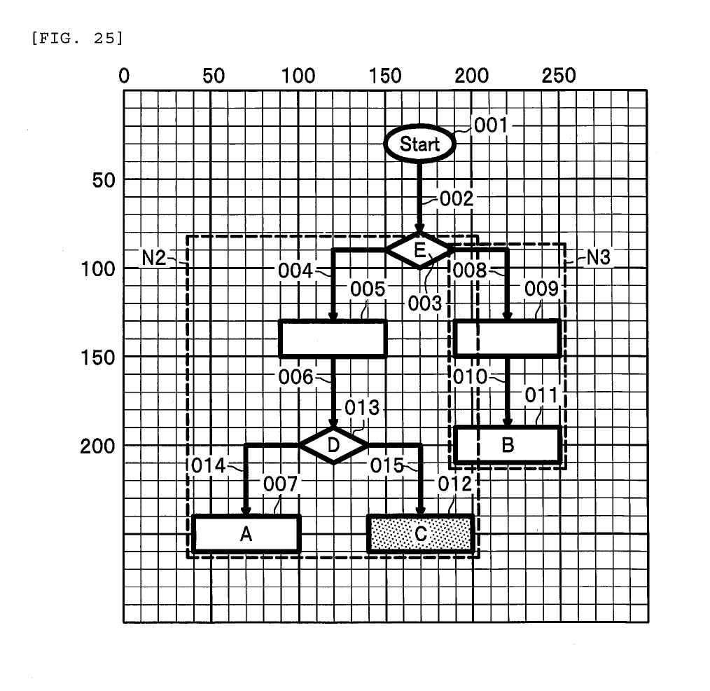

First, in step S101 of the process routine of the flowchart drawing apparatus 1 according to the embodiment, shown in FIG. 15, node group organization is performed. In an example of FIG. 23, a set of parts with the branch node E 003 being a boundary is indicated as a broken line as Node group 309. The organization result of Node group 309 is shown in the part information table 300 in FIG. 24. The part information table 300 is divided into three Node groups 309 of “N1”, “N2” and “N3” using the branch node E 003 as a boundary.

Further, in step S103 of FIG. 15, the data input section 201 receives an input of a newly added part (process C 012) according to a user's operation of the input apparatus 2. Subsequently, the part information managing section 202 stores information about the received process C 012 in the part information table 300. Further, the part information managing section 202 performs the processes of steps S301 to S305 in FIG. 15, to thereby execute a display position adjustment process (parallel connection). The display position adjustment (step S305) of the parallel connection is performed in a node group (N2) to which the existing part (process A 007) overlapped with the input part (process C 012) belongs.

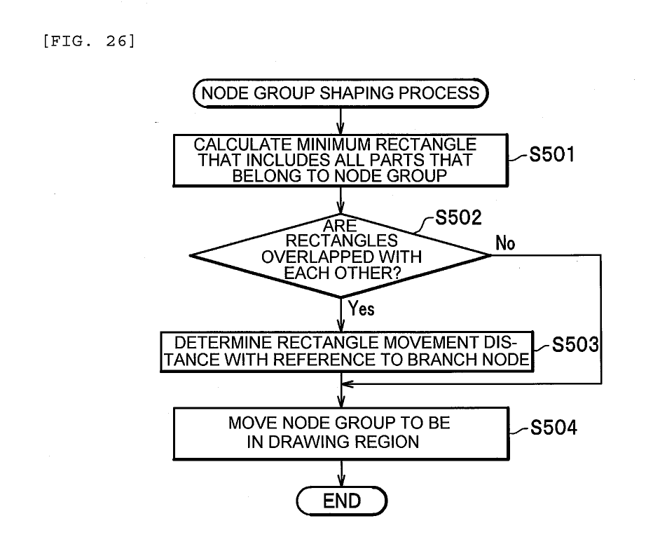

Next, the node group shaping process in step S109 of FIG. 15 will be described in detail. FIG. 25 is a diagram virtually illustrating an example of a flowchart at the time when the display position adjustment process (parallel connection) up to step S305 in FIG. 15 is terminated. As shown in FIG. 25, a rectangle that indicates the node group “N2” including the process C 012 is overlapped with a rectangle that indicates a node group “N3”. In this state, the distance between a connector 015 and the process C 012 of the node group “N2” and a process B 011 of the node group “N3” is short. Accordingly, in a case where a node is later added to the process C 012 or the process B 011, it is expected that a part in each node group may be overlapped with a part in an adjacent node group. For this reason, the node group shaping process is performed after the display position adjustment process in the node group.

FIG. 26 is a flowchart illustrating the flow of a node group shaping process according to the embodiment.

First, the flow position calculating section 203 of the flowchart drawing apparatus 1 calculates, for each node group, a minimum rectangle that includes overall parts that belong to the node group (step S501). The process result becomes a rectangle indicated by a broken line in FIG. 25.

Next, the flow position calculating section 203 determines whether the calculated each rectangle is overlapped with a rectangle of a different node group (step S502). Further, in a case where the calculated rectangle is not overlapped with the rectangle of the different node group (step S502−>No) in the flow position calculating section 203, the procedure goes to step S504.

On the other hand, in a case where the calculated rectangle is overlapped with the rectangle of the different node group (step S502−>Yes), the flow position calculating section 203 determines the movement distance of the rectangle with reference to the branch node that divides the node groups (step S503). As shown in FIG. 25, in a case where two node groups are overlapped with each other with the branch node being interposed therebetween, a process is performed so that one node group is not arranged on the side of the other node group with reference to the branch node that is a reference, to thereby prevent overlapping of the rectangles of the node groups. For example, in the present example, the flow position calculating section 203 moves the node group “N2” on the left side to be arranged on the left side with reference to a coordinate of the left end of a diamond shape of the branch node E 003. Further, in FIG. 25, in order to match the right end of the rectangle of the node group N2 with the left end of the diamond shape of the branch node 003, the distance of the node group “N2” on the left side moves to the left as much as “50”. In the node group “N3” on the right side, there is no possibility of overlapping, but in order to perform horizontally symmetric shaping using the branch node 003 as a support point, a movement distance of the node group “N2” to the right is set to “50”.

Next, the flow position calculating section 203 moves a flowchart that includes the respective node groups to be accommodated in a drawing region (step S504). For example, as shown in FIG. 25, in a case where an X coordinate of the left end of the node group “N2” is “40” and the node group “N2” cannot thus move to the left as much as “50” that is the movement distance set in step S503, with reference to the position of a part of the node group located on the leftmost side in the node group, the other parts are moved.

Further, the result after the node group shaping process is terminated is shown in FIG. 27. According to this configuration, it is possible to determine the parallel connection process by only user's overlapping of a new process with an existing process, and to move a flowchart to a position coordinate where node groups are not overlapped with each other for drawing without an additional operation.

### REFERENCE SIGNS LIST

1 FLOWCHART DRAWING APPARATUS

2 INPUT APPARATUS

3 DISPLAY APPARATUS

10 CPU

20 MEMORY

30 STORAGE UNIT

40 INPUT AND OUTPUT UNIT

41 INPUT INTERFACE

42 OUTPUT INTERFACE

200 FLOWCHART DRAWING SECTION

201 DATA INPUT SECTION

202 PART INFORMATION MANAGING SECTION

203 FLOW POSITION CALCULATING SECTION

204 FLOW DISPLAY SECTION

300 PART INFORMATION TABLE (PART INFORMATION)

1. A flowchart drawing apparatus that adjusts display positions of a plurality of nodes and a connector that connects the plurality of nodes and indicates a process flow of the nodes, in which the nodes and the connector form a flowchart, to be displayed on a display apparatus, the flowchart drawing apparatus comprising:
a storage unit that stores part information including coordinate information that indicates the display positions of the nodes and the connector and information about connection of the nodes and the connector;
a data input section that receives an input of information relating to a node to be added to the flowchart from an input apparatus;
a part information managing section that determines whether a display position of the input node and the display position of the connector that forms the flowchart are overlapped with each other on the basis of the part information, determines, in a case where it is determined that the input node and the connector are overlapped with each other, a connection relationship between the nodes so that the input node is inserted between an upper node and a lower node connected to the overlapped connector, and newly sets a connector that connects the input node and the upper node and a connector that connects the input node and the lower node in the part information of the flowchart;
a flow position calculating section that determines display positions of the input node, the lower node, the connector that connects the input node and the upper node, and the connector that connects the input node and the lower node, with reference to a display position of the upper node; and
a flow display section that displays the flowchart on the display apparatus on the basis of the determined display positions.

2. The flowchart drawing apparatus according to claim 1,
wherein the part information managing section determines whether the display position of the input node and a display position of the node that forms the flowchart are overlapped with each other on the basis of the part information, newly sets a branch node that branches the process flow in the part information of the flowchart, in a case where it is determined that the input node and the node are overlapped with each other, and sets the input node and the overlapped node as branch destinations of the newly set branch node, and
wherein the flow position calculating section determines display positions so that the input node and the overlapped node are equivalently arranged, with reference to the set branch node.

3. The flowchart drawing apparatus according to claim 2,
wherein the flow position calculating section sets each of sets of the nodes positioned on a lower side of the branch node, that are the branch destinations, and the connectors as a node group, acquires the coordinate information about display positions of each node and each connector that form the node group from the part information, and calculates a minimum rectangle including each node and each connector that form the node group for each node group, and changes, in a case where the calculated rectangle of the node group is overlapped with a rectangle of a different node group, a display position of the overlapped node group with reference to a display position of the branch node.

4. A flowchart drawing method in a flowchart drawing apparatus that adjusts display positions of a plurality of nodes and a connector that connects the plurality of nodes and indicates a process flow of the nodes, in which the nodes and the connector form a flowchart, to be displayed on a display apparatus,
the flowchart drawing apparatus including a storage unit that stores part information including coordinate information that indicates the display positions of the nodes and the connector and information about connection of the nodes and the connector,
the method comprising:
a step of receiving an input of information relating to a node to be added to the flowchart from an input apparatus;
a step of determining whether a display position of the input node and the display position of the connector that forms the flowchart are overlapped with each other on the basis of the part information, and determining, in a case where it is determined that the input node and the connector are overlapped with each other, a connection relationship between the nodes so that the input node is inserted between an upper node and a lower node connected to the overlapped connector;
a step of newly setting a connector that connects the input node and the upper node and a connector that connects the input node and the lower node in the part information of the flowchart;
a step of determining display positions of the input node, the lower node, the connector that connects the input node and the upper node, and the connector that connects the input node and the lower node, with reference to a display position of the upper node; and
a step of displaying the flowchart on the display apparatus on the basis of the determined display positions.

5. The flowchart drawing method according to claim 4, further comprising:
a step of determining whether the display position of the input node and a display position of the node that forms the flowchart are overlapped with each other on the basis of the part information, newly setting a branch node that branches the process flow in the part information of the flowchart, in a case where it is determined that the input node and the node are overlapped with each other, and setting the input node and the overlapped node as branch destinations of the newly set branch node; and
a step of determining display positions so that the input node and the overlapped node are equivalently arranged, with reference to the set branch node.

6. The flowchart drawing method according to claim 5, further comprising:
a step of setting each of sets of the nodes positioned on a lower side of the branch node, that are the branch destinations, and the connectors as a node group, and acquiring the coordinate information about display positions of each node and each connector that form the node group from the part information; and
a step of calculating a minimum rectangle including each node and each connector that form the node group for each node group, and changes, in a case where the calculated rectangle of the node group is overlapped with a rectangle of a different node group, a display position of the overlapped node group with reference to a display position of the branch node.

7. A program that causes a computer to execute the flowchart drawing method according to claim 4.

8. A program that causes a computer to execute the flowchart drawing method according to claim 5.

9. A program that causes a computer to execute the flowchart drawing method according to claim 6.
